(19) United States
(12) Patent Application Publication
(10) Pub. No.: US 2013/0117508 A1
(43) Pub. Date: May 9, 2013

(54) ELECTRONIC DEVICE SYSTEM, ELECTRONIC DEVICE, AND STORAGE MEDIUM

(71) Applicant: SHARP KABUSHIKI KAISHA, Osaka (JP)

(72) Inventor: Tetsuji Yamamoto, Osaka-shi (JP)

(73) Assignee: SHARP KABUSHIKI KAISHA, Osaka (JP)

(21) Appl. No.: 13/670,758

(22) Filed: Nov. 7, 2012

(30) Foreign Application Priority Data
Nov. 8, 2011 (JP) 2011244710

(51) Int. Cl. G06F 12/00

(52) U.S. Cl. 711/115; 711/E12.001

(57) ABSTRACT

An electronic device system, an electronic device and a storage device that prevent the processing by a program stored in a non-certified storage medium are provided.

An SDIO device 102 stores a program and identification information, outputs the program from an SD pin unit 40, and outputs the identification information from an extended pin unit 41. An electronic device 101 has an SD pin unit 30 connected to an SD pin unit 40 and an extended pin unit 31 connected to an extended pin unit 41, and reads the program by an SD host controller 13 connected to the SD pin unit 30. A device determination unit 15 determines whether the identification information obtained through the extended pin unit 41 coincides with the prestored identification information or not. When it is determined that the identification information coincides, a processing unit 10 executes processing by the read program.

### CROSS-REFERENCE TO RELATED APPLICATIONS

This Nonprovisional application claims priority under 35 U.S.C. §119(a) to Patent Application No. 2011-244710 filed in Japan on Nov. 8, 2011, the entire contents of which are hereby incorporated by reference.

### BACKGROUND

1. Technical Field

The present invention relates to: an electronic device system provided with a storage medium and an electronic device to which the storage medium is detachably and attachably connected and that executes processing by a program read from the storage medium; the electronic device; and the storage medium.

2. Description of Related Art

Many electronic devices such as notebook PCs (personal computers) and tablet portable terminals are provided with a connection interface to which an external device is connected to perform data transfer. The electronic devices, for example, read data of music, video and the like stored in the device connected to the connection interface and use it, and further, it is performed to activate the electronic device by a program installed on the connected device. An example of the connection interface that the electronic devices are provided with is an SD (secure digital) interface, and an example of the connected device is an SD memory card having the SD interface.

Japanese Patent Application Laid-Open No. 2007-086920 discloses a portable electronic device having a CPU (central processor unit), a RAM (random access memory), a memory controller, a reset controller, an SD memory card and a key matrix. This portable electronic device reads a boot program from the SD memory card and executes it when receiving power supply from an external power source under a condition where a specific key in the key matrix is depressed. Specifically, the memory controller relocates the RAM at address 0 of the memory address, and reads the boot program stored in the SD memory card into the RAM. The reset controller holds the CPU in reset state during the reading of the boot program from the SD memory card, and after the reading, the reset controller releases the CPU from the reset state. The CPU having been released from the reset state starts a fetch from address 0 of the memory address, whereby the processing by the boot program read into the RAM is executed. Thereby, even in a case such as when no boot program is present in the portable electronic device or when although the boot program is present, it does not run normally because of an initial failure, the portable electronic device can be activated by the boot program stored in the SD memory card.

### SUMMARY OF THE INVENTION

However, according to the technology described in Japanese Patent Application Laid-Open No. 2007-086920, with an electronic device activated by a program read from an SD memory card storing the program, there is a problem in that the program is illegally copied to another SD memory card and used for another electronic device.

For example, when the program is illegally copied from a certified SD memory card provided by the manufacturer of the electronic device to a non-certified SD memory card of a different quality and the non-certified SD memory card is connected to the electronic device, a problem occurs in that a program read error is caused or that the program read speed is reduced to retard the operation of the electronic device.

The present invention is made in view of such circumstances, and an object thereof is to provide an electronic device system, an electronic device and a storage device that prevent the processing by a program stored in a non-certified storage medium.

In an electronic device system according to the present invention provided with: a storage medium storing a program; and an electronic device to which the storage medium is detachably connected so as to execute processing by a program read from the storage medium, the storage medium is provided with: a storage unit storing the program and identification information; a first pin for outputting the program stored in the storage unit; and a second pin for outputting the identification information stored in the storage unit, and the electronic device is provided with: a third pin connected to the first pin; a fourth pin connected to the second pin; a program reading unit connected to the third pin for reading the program; a determination unit for determining whether or not the identification information obtained through the fourth pin coincides with prestored identification information; and a processing unit that executes processing by the program read by the program reading unit when the determination unit determines that the identification information coincides. This enables a structure in which when the identification information coincides, the storage medium is determined as certified and the processing by the program is executed.

In the electronic device system according to the present invention, the program reading unit reads the program when the determination unit determines that the identification information coincides. Consequently, the program stored in a non-certified storage medium can be prevented from being read.

In the electronic device system according to the present invention, the determination unit notifies the processing unit of the determination result, and the processing unit starts processing by the program read by the program reading unit, prior to the notification of the determination result, and when the determination result indicates that the identification information does not coincide, the processing unit stops processing by the program. Consequently, the processing by the program can be started early, and the execution of the control program stored in a non-certified storage medium can be stopped.

In the electronic device system according to the present invention, the storage medium is an SDIO (secure digital input output) compliant memory card in which a plurality of pins including the first pin have an SD interface and the second pin is provided. Consequently, the storage medium can be structured so as to be compliant with SDIO.

In the electronic device system according to the present invention, the electronic device is provided with an identification information obtaining unit connected to the fourth pin so as to obtain the identification information stored in the storage unit and output the identification information to the determination unit, and the identification information obtaining unit outputs predetermined information when the identification information stored in the storage unit is not detected. Consequently, the determination by the determination unit can also be made on a non-certified storage medium from which no identification information is outputted.

In an electronic device according to the present invention that reads a program from an external storage medium and executes processing, the following are provided: a program input pin to which the program is inputted; an identification information input pin to which identification information is externally inputted; a program reading unit connected to the program input pin for reading the program; a determination unit for determining whether or not the identification information obtained through the identification information input pin coincides with prestored identification information; and a processing unit that executes processing by the program read by the program reading unit when the determination unit determines that the identification information coincides. This enables a structure in which when the identification information coincides, the storage medium is determined as certified and the processing by the program is executed.

In the electronic device according to the present invention, the program reading unit reads the program when the determination unit determines that the identification information coincides. Consequently, the program stored in a non-certified storage medium can be prevented from being read.

In the electronic device according to the present invention, the determination unit notifies the processing unit of the determination result, and the processing unit starts processing by the program read by the program reading unit, prior to the notification of the determination result, and when the determination result indicates that the identification information does not coincide, the processing unit stops processing by the program. Consequently, the processing by the program can be started early, and the execution of the control program stored in a non-certified storage medium can be stopped.

The electronic device according to the present invention is provided with an identification information obtaining unit connected to the identification information input pin so as to obtain the inputted identification information and output the identification information to the determination unit, and the identification information obtaining unit outputs predetermined information when the identification information to be inputted is not detected. Consequently, the determination by the determination unit can also be made on a non-certified storage medium from which no identification information is outputted.

In a storage medium according to the present invention connected to an external electronic device and from which a stored program is read, the following are provided: a storage unit storing the program and identification information; a pin for outputting the program; and a pin for outputting the identification information. Consequently, the identification information from a pin different from the pin that outputs the program can be outputted to an external electronic device so as to undergo a determination as to whether the medium is a certified one or not by the electronic device.

The storage medium according to the present invention is an SDIO compliant memory card in which a plurality of pins including the pin for outputting the program have an SD interface and the pin for outputting the identification information is provided. Consequently, the storage medium can be structured so as to be compliant with SDIO.

According to the present invention, the storage medium stores the program and the identification information, the first pin outputs the program and the second pin outputs the identification information. The electronic device reads the program by the program reading unit connected to the third pin connected to the first pin, and determines whether the identification information obtained through the fourth pin connected to the second pin coincides with the prestored identification information or not by the determination unit. When the determination unit determines that the identification information coincides, the processing unit executes processing by the program read by the program reading unit. This enables a structure in which when the identification information coincides, the storage medium is determined as certified and the processing by the program is executed.

The above and further objects and features of the invention will more fully be apparent from the following detailed description with accompanying drawings.

### BRIEF DESCRIPTION OF THE SEVERAL VIEWS OF THE DRAWINGS

FIG. 1 is a conceptual view showing the appearance of an electronic device system of the present invention;

FIG. 2 is a block diagram showing the functional structure of the inside of an electronic device and an SDIO device included in the electronic device system according to a first embodiment;

FIG. 3 is a schematic view showing the structure of connector units of the electronic device and the SDIO device;

FIG. 4 is a table showing the pin assignment of SD pin units of the electronic device and the SDIO device;

FIG. 5 is a table showing the pin assignment of extended pin units of the electronic device and the SDIO device;

FIG. 6 is a flowchart showing the processing procedure when the control program is read from the SDIO device to the electronic device and executed;

FIG. 7 is a block diagram showing the functional structure of the inside of the electronic device and the SDIO device included in the electronic device system according to a second embodiment; and

FIG. 8 is a flowchart showing the processing procedure when the control program is read from the SDIO device to the electronic device and executed in the second embodiment.

### DETAILED DESCRIPTION

### First Embodiment

Hereinafter, the present invention will be concretely described based on the drawings showing embodiments thereof.

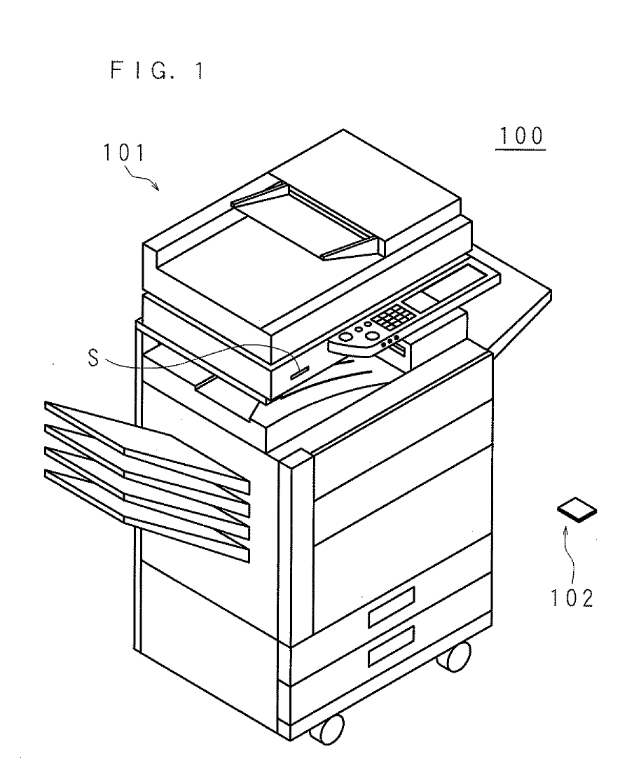

FIG. 1 is a conceptual view showing the appearance of an electronic device system 100 of the present invention. The electronic device system 100 of the present invention is provided with an electronic device 101 and an SDIO (secure digital input output) device 102 detachably attachable to the electronic device 101. In the present embodiment, an example in which the electronic device system 100 is an image forming apparatus is shown. The SDIO device 102 is, for example, an SDIO compliant memory card having a nine-pin SD interface. The SDIO device (storage medium) 102 is connected to the electronic device 101, and stores a control program read by the electronic device 101 and the identification information of the SDIO device 102. While the electronic device system 100 shown in FIG. 1 is structured so that the SDIO device 102 is attached by being inserted into an insertion and extraction slot S provided on the housing of the electronic device 101, it may be structured so that the SDIO device 102 is detachably attached to an electronic circuit board (not shown) provided in the housing of the electronic device 101.

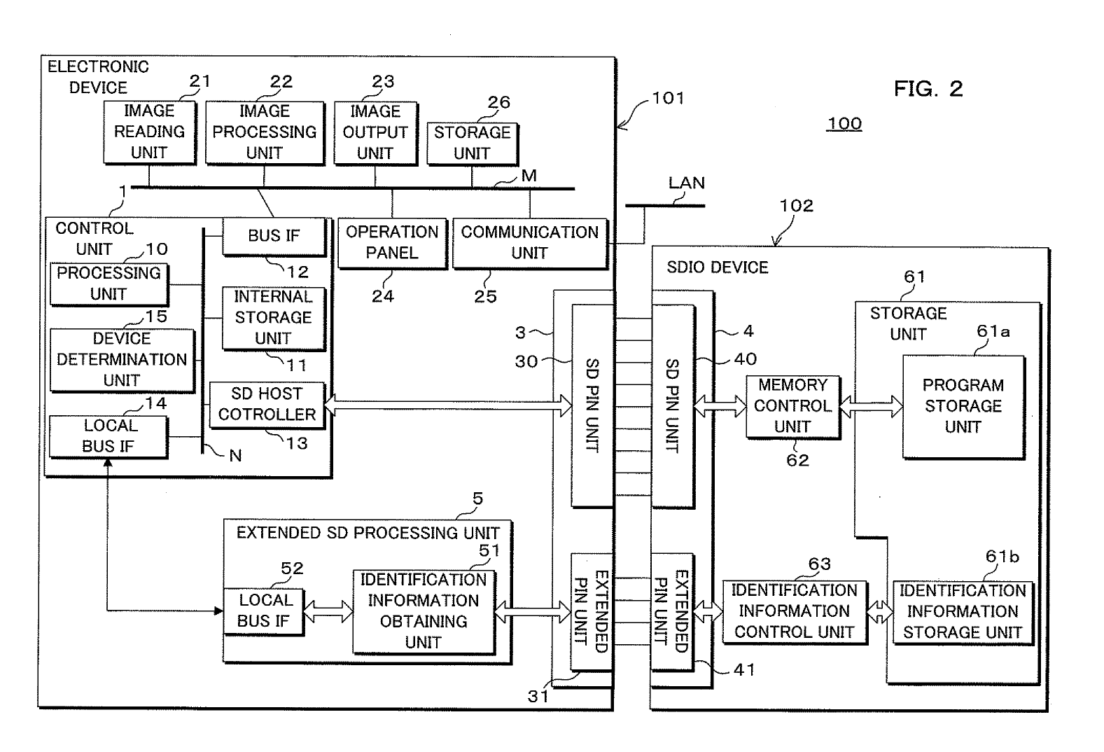

FIG. 2 is a block diagram showing the functional structure of the inside of the electronic device 101 and the SDIO device 102 included in the electronic device system 100 according to a first embodiment. The electronic device 101 is provided with an image reading unit 21, an image processing unit 22, an image output unit 23, an operation panel 24, a communication unit 25 and a storage unit 26, and these pieces of hardware are connected to a control unit 1 by a bus M. The control unit 1 controls these pieces of hardware by executing the processing by the control program read from the SDIO device 102, thereby activating the electronic device 101. These as a whole constitute an image forming apparatus. The electronic device 101 is also provided with an extended SD processing unit 5 and an SD connector unit 3. The extended SD processing unit 5 is connected to the control unit 1 by a local bus, and the SD connector unit 3 is connected to the control unit 1 and the extended SD processing unit 5.

The image reading unit 21 is provided with an optical unit having an image sensor such as a CCD (charge coupled device) or the like, and optically reads the image data of an original document. The image reading unit 21 forms a reflected light image from the original document on the image sensor, and outputs an RGB (R: red, G: green, B: blue) signal. The RGB signal outputted by the image reading unit 21 is inputted to the image processing unit 22.

The image processing unit 22 generates image data based on the RGB signal outputted from the image reading unit 21 or reads the image data stored in the storage unit 26, processes the image data according to the kind of the image, and then, generates output image data. The output image data generated by the image processing unit 22 is outputted to the image output unit 23 or the communication unit 25.

The image output unit 23 forms an image on a sheet such as a recording paper or an OHP film based on the output image data outputted from the image processing unit 22. The image output unit 23 is provided with: a photoconductor drum; a charger that charges the photoconductor drum to a predetermined potential; an exposing device that generates an electrostatic latent image on the photoconductor drum by emitting laser light or the like according to the externally accepted image data; a developer unit that develops the electrostatic latent image formed on the photoconductor drum surface by supplying toner thereto; and a transferer that transfers the toner image formed on the photoconductor drum surface onto the sheet (these are not shown). The image output unit 23 forms an image desired by the user on the sheet by an electrophotographic method. Instead of performing image formation by an electrophotographic method, the image output unit 23 may perform image formation by an ink-jet method, a thermal transfer method, a sublimation method or the like.

The operation panel 24 is provided with: function buttons such as “facsimile”, “copy”, “print” and “mail” related to various functions of the image forming apparatus; a numeric keypad; an enter key for entering the accepted instruction; and a liquid crystal display, and obtains an operation signal by the user.

The communication unit 25 is provided with a network card, a modem or the like for establishing connection with a network such as a LAN to transmit the output image data to the outside. The storage unit 26 is a storage device such as a non-volatile semiconductor memory or a hard disk, and stores image data for image processing and the like.

The control unit 1 is provided with a processing unit 10, an internal storage unit 11, a bus interface 12 (hereinafter, referred to as bus IF 12), an SD host controller (program reading unit) 13, a local bus interface 14 (hereinafter, referred to as local bus IF 14) and a device determination unit (determination unit) 15. These pieces of hardware are connected by an internal bus N of the control unit 1. The processing unit 10 is a CPU that executes the processing by a program. The internal storage unit 11 is provided with a ROM (read only memory) storing the boot program and the identification information of the SDIO device 102 and a RAM storing data generated in the program processing. The boot program is the program that is executed first by the processing unit 10 when the electronic device 101 is turned on.

The bus IF 12 controls the input and output of the internal bus N of the control unit 1 and the bus M to which the image reading unit 21 and the like are connected. The SD host controller 13 outputs a command to the SDIO device 102 to control data reading and writing with the SDIO device 102. While the SD host controller 13 is provided in the control unit 1 in FIG. 2, a part having an SD host controller may be mounted by an SOC (system on a chip), a south bridge chip set or the like. The local bus IF 14 controls the input and output of the local bus connecting the extended SD processing unit 5.

The device determination unit 15 determines whether the identification information outputted from the SDIO device 102 and obtained and the identification information of the SDIO device 102 stored in the ROM of the internal storage unit 11 coincide with each other or not. When the pieces of identification information coincide with each other as a result of the determination, the control unit 1 determines the attached SDIO device 102 as certified, and when the pieces of identification information do not coincide with each other, the control unit 1 determines the attached SDIO device 102 as non-certified.

The extended SD processing unit 5 is provided with an identification information obtaining unit 51 and a local bus IF 52, obtains the identification information from the SDIO device 102, and outputs the identification information to the control unit 1 through the local bus. The identification information obtaining unit 51 is connected to an extended pin unit 31 in the connector unit 3 described later, obtains the identification information from the SDIO device 102 through the extended pin unit 31, and holds it. When receiving an identification information output request from the control unit 1, the extended SD processing unit 5 outputs the identification information held by the identification information obtaining unit 51 to the control unit 1 through the local bus by the local bus IF 52. The extended SD processing unit 5 may be constituted by a CPLD (complex programmable logic device) or an FPGA (field programmable gate array).

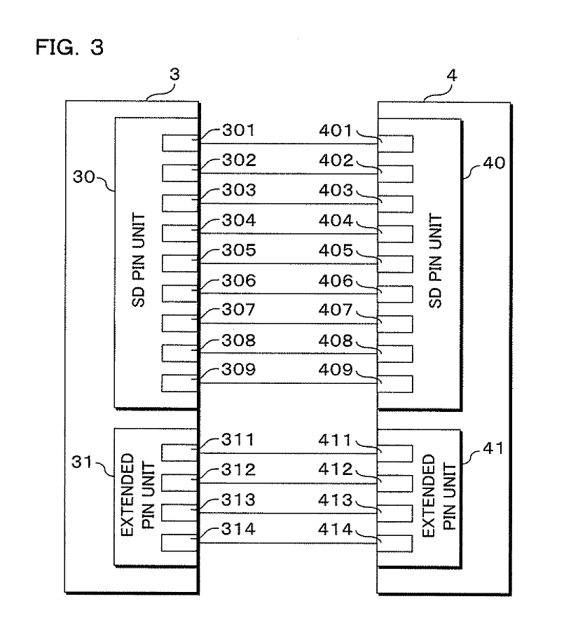

The connector unit 3 is provided with an SD pin unit 30 and the extended pin unit 31. FIG. 3 is a schematic view showing the structure of the connector units of the electronic device 101 and the SDIO device 102. The SD pin unit 30 has an SD interface constituted by nine pins of pins (the third pin, the program input pin) 301 to 309, and is connected to an SD pin unit 40 of a connector unit 4 in the SDIO device 102 described later. The extended pin unit 31 has four pins of pins (the fourth pin, the identification information input pin) 311 to 314, and is connected to an extended pin unit 41 of the connector unit 4 in the SDIO device 102 described later. The SD pin unit 30 is connected to the SD host controller 13, and the extended pin unit 31 is connected to the identification information obtaining unit 51.

The SDIO device 102 is provided with a storage unit 61, a memory control unit 62, an identification information control unit 63 and the connector unit 4. The storage unit 61 has a program storage unit 61a storing the control program read and executed by the electronic device 101 and an identification information storage unit 61b storing the identification information of the SDIO device 102. The program storage unit 61a and the identification information storage unit 61b may be constituted by separate non-volatile semiconductor memories or the like, respectively, or may be constituted by an integral non-volatile semiconductor memory or the like.

The memory control unit 62 performs data reading from the program storage unit 61a and data writing to the program storage unit 61a based on the command from the SD host controller 13. The memory control unit 62 is connected to the SD pin unit 40, obtains the command from the SD host controller 13 through the SD pin unit 40, and outputs the control program stored in the program storage unit 61a to the SD host controller 13.

The identification information control unit 63 is connected to the identification information storage unit 61b and the extended pin unit 41 described later, reads the identification information of the SDIO device 102 stored in the identification information storage unit 61b, and outputs the identification information to the extended SD processing unit 5 through the extended pin unit 41. The identification information control unit 63 may be constituted by a CPLD or an FPGA. Moreover, the identification information control unit 63 and the identification information storage unit 61b may be constituted by a CPLD or an FPGA.

The connector unit 4 is provided with the SD pin unit 40 and the extended pin unit 41. The SD pin unit 40 has an SD interface constituted by nine pins of pins (the first pin, the pin that outputs the program) 401 to 409, and is connected to the SD pin unit 30 of the connector unit 3 in the electronic device 101 (see FIG. 3). The extended pin unit 41 has four pins of pins (the second pin, the pin that outputs the identification information) 411 to 414, and is connected to the extended pin unit 31 of the connector unit 3 in the electronic device 101. The extended pin unit 41 is provided in an area other than the area occupied by the SD pin unit 40 on the outer surface of the SDIO device 102.

For example, when the SDIO device 102 is a rectangular memory card substantially the same as an SD memory card, the nine pins of the SD pin unit 40 are arranged on one marginal part of the rectangular memory card like the known SD memory card. The four pins of the extended pin unit 41 are provided, for example, in a substantially central part of the card surface other than the area occupied by the SD pin unit 40. At this time, the pins of the extended pin unit 41 are formed of the same material as the pins of the SD pin unit 40 in substantially the same shape and size. The four pins of the extended pin unit 41 may be arranged in two rows and two columns or may be arranged in one row and four columns. The connector unit 3 on the side of the electronic device 101 is a known SD memory card socket to which the extended pin unit 31 for connection with the extended pin unit 41 is added. For example, the connector unit 3 may be one in which the four pins of the extended pin unit 31 are provided so as to be pressed against the four pins of the extended pin unit 41 in positions opposite to the four pins of the extended pin unit 41 provided in the substantially central part of the card surface.

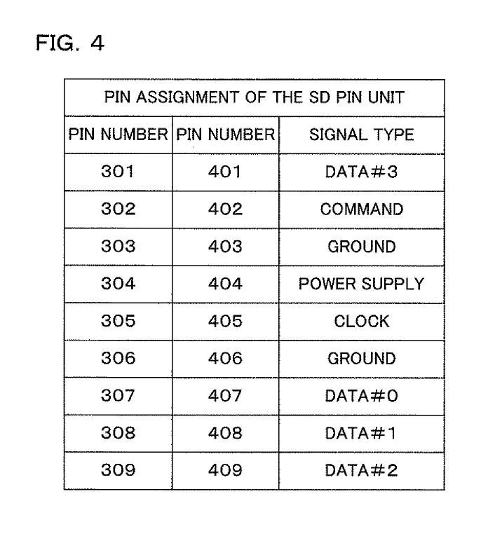

FIG. 4 is a table showing the pin assignment of the SD pin units of the electronic device 101 and the SDIO device 102. Hereinafter, the pin assignment will be explained by using the pin numbers on the side of the SD pin unit 30, and the corresponding pin numbers on the side of the SD pin unit 40 are shown in the parentheses. The pins 307 to 309 (pins 407 to 409) are assigned to data #0 to data #2, respectively, and the pin 301 (pin 401) is assigned to data #3. The SDIO device 102 outputs the control program stored in the program storage unit 61a through the pins 401 and 407 to 409. The electronic device 101 reads the control program by the SD host controller 13 through the pins 301 and 307 to 309.

The pin 302 (pin 402) is assigned for a command such as a command to perform reading and writing from the SD host controller 13 to the SDIO device 102. The pins 303 and 306 (pins 403 and 406) are assigned to grounding, the pin 304 (pin 404) is assigned to power supply, and the pin 305 (pin 405) is assigned to clock.

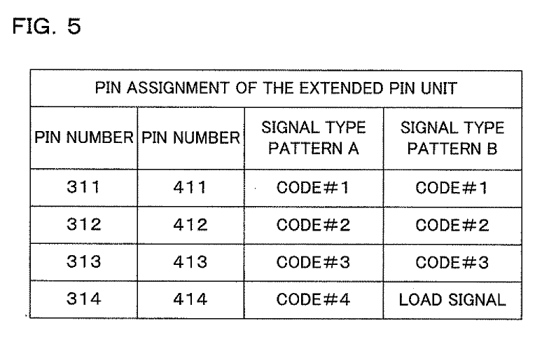

FIG. 5 is a table showing the pin assignment of the extended pin units of the electronic device 101 and the SDIO device 102. In FIG. 5, a pattern A and a pattern B are shown as examples of the pin assignment of the extended pin units. Hereinafter, the pin assignment will be explained by using the pin numbers on the side of the extended pin unit 31, and the corresponding pin numbers on the side of the extended pin unit 41 are shown in the parentheses. In the pattern A, the pins 311 to 314 (pins 411 to 414) are all assigned to codes, and the identification information is outputted from the SDIO device 102 by using all the four pins. In the pattern A, the identification information is four-bit information such as “0111”, and the codes #1 to #4 are associated with the bits of the identification information so that the code #1 is “0”, the code #2 is “1”, the code #3 is “1” and the code #4 is “1”.

In the pattern B, the pins 311 to 313 (pins 411 to 413) are assigned to codes, and the pin 314 (pin 414) is assigned to load signal. In the pattern B, the identification information is three-bit information such as “011”, and the codes #1 to #3 are associated with the bits of the identification information so that the code #1 is “0”, the code #2 is “1” and the code #3 is “1”. The load signal is, for example, a signal that takes a value of LOW or HIGH, and the identification information obtaining unit 51 outputs the load signal to the pin 314. When the load signal outputted from the identification information obtaining unit 51 is changed from LOW to HIGH, the identification information control unit 63 outputs the identification information (for example, “011”) to the pins 411 to 413. When the load signal outputted from the identification information obtaining unit 51 is returned from HIGH to LOW, the identification information control unit 63 stops the output of the identification information.

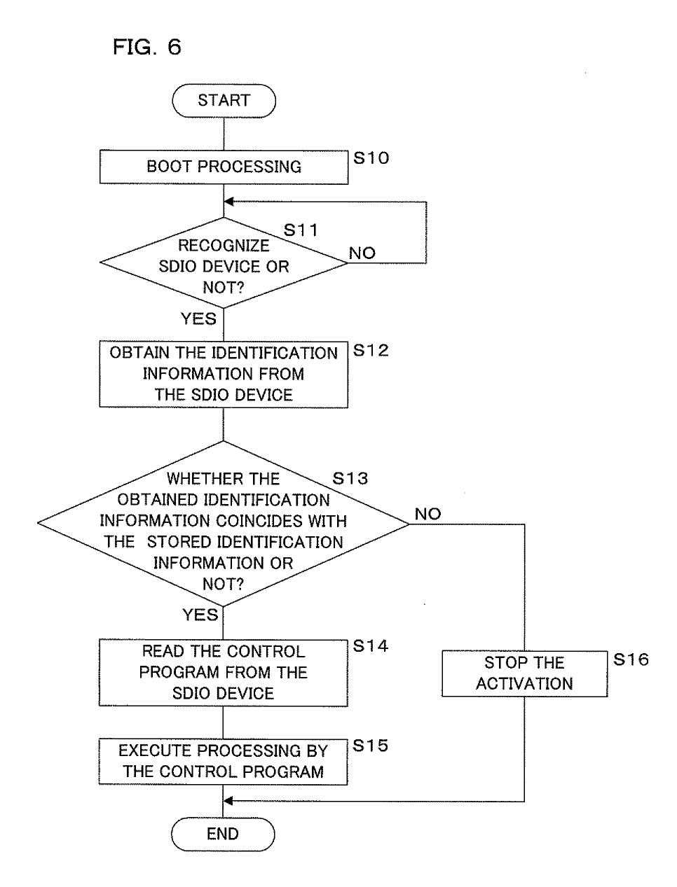

Next, the processing when the control program is read from the SDIO device 102 to the electronic device 101 and executed will be described. FIG. 6 is a flowchart showing the processing procedure when the control program is read from the SDIO device 102 to the electronic device 101 and executed. When the electronic device 101 is turned on, the control unit 1 performs the boot processing (step S10). In the boot processing, the processing unit 10 executes the boot program stored in the ROM of the internal storage unit 11, performs the initialization and operation check of the pieces of hardware in the control unit 1 and connected to the bus M, and establishes the input and output relationship among the pieces of hardware.

After the boot processing at step S10, the processing unit 10 checks whether the SDIO device 102 has been recognized or not (step S11). When the connector unit 4 of the SDIO device 102 is attached to the connector unit 3 of the electronic device 101, the SDIO device 102 is automatically recognized on the side of the SD host controller 13 by the SD interface. When the SDIO device 102 has not been recognized (S11: NO), step S11 is repeated until the SDIO device 102 is recognized.

When the SDIO device 102 has been recognized (S11: YES), the processing to obtain the identification information from the SDIO device 102 is performed (step S12). The extended SD processing unit 5 has obtained the identification information from the SDIO device 102 through the extended pin unit 31 by the identification information obtaining unit 51 and holds the identification information, and when receiving the identification information output request from the control unit 1, the extended SD processing unit 5 outputs the identification information to the control unit 1 through the local bus. The device determination unit 15 obtains the identification information of the SDIO device 102 outputted from the extended SD processing unit 5.

Then, the device determination unit 15 determines whether the identification information obtained from the extended SD processing unit 5 coincides with the identification information of the SDIO device 102 stored in the ROM of the internal storage unit 11 or not (step S13). When the identification information coincides as a result of the determination by the device determination unit 15 (S13: YES), the control unit 1 determines the SDIO device 102 as a certified one, and the control program is read from the SDIO device 102 through the SD pin unit 30 by the SD host controller 13 (step S14). The processing unit 10 executes processing by the control program read by the SD host controller 13 (step S15). On the other hand, when the identification information does not coincide as a result of the determination by the device determination unit 15 (S13: NO), the control unit 1 determines the SDIO device 102 as a non-certified one, and stops the activation of the electronic device 101 without executing the control program (step S16).

As described above, according to the present embodiment, the control program and the identification information are stored in the storage unit 61 of the SDIO device 102, the control program is outputted by the SD pin unit 40 including the pins 401 and 407 to 409, and the identification information is outputted by the extended pin unit 41 including the pins 411 to 414. The electronic device 101 is provided with the SD pin unit 30 connected to the SD pin unit 40, and the control program is read by the SD host controller 13 connected to the pins 301 and 307 to 309 corresponding to the pins 401 and 407 to 409. Moreover, the electronic device 101 is provided with the extended pin unit 31 connected to the extended pin unit 41, and the identification information stored in the SDIO device 102 is obtained by the identification information obtaining unit 51 through the pins 311 to 314 corresponding to the pins 411 to 414. The device determination unit 15 determines whether the identification information obtained by the identification information obtaining unit 51 coincides with the identification information stored in the internal storage unit 11 or not, and when it is determined that the identification information coincides, the processing unit 10 executes the processing by the control program read by the SD host controller 13. When the identification information coincides, the control unit 1 determines the SDIO device 102 as certified, and executes the processing by the control program, and when the identification information does not coincide, the control unit 1 determines the SDIO device 102 as non-certified, and does not execute the processing by the control program. By doing this, the processing by the control program stored in a non-certified SDIO device can be prevented from being executed.

Moreover, in the present embodiment, since the control program stored in the SDIO device 102 is read by the SD host controller 13 when the device determination unit 15 determines that the identification information coincides, the control program stored in a non-certified SDIO device can be prevented from being read.

Moreover, in the present embodiment, the identification information obtaining unit 51 may previously hold predetermined information such as “0000” or “1111” instead of the identification information and output the predetermined information to the control unit 1 when no identification information can be obtained from the connected SDIO device 102. In a case such as when the connected SDIO device 102 is an SD memory card having no extended pin unit 41, the identification information obtaining unit 51 cannot obtain the identification information from the SD memory card. By the predetermined information being information different from the identification information stored in the internal storage unit 11 of the control unit 1, the device determination unit 15 can determine that the identification information does not coincide when the predetermined information is outputted from the extended SD processing unit 5. By doing this, a non-certified device having no extended pin unit 41 and from which no identification information is outputted can be identified, the processing by the control program stored in the device can be prevented from being executed, and further, the control program can be prevented from being read.

Moreover, in the present embodiment, the SDIO device 102 connected to the electronic device 101 is an SDIO compliant memory card in which the SD pin unit 40 including the pins 401 and 407 to 409 has an SD interface and the extended pin unit 41 including the pins 411 to 414 is provided. Consequently, the SDIO device 102 to be connected to the electronic device 101 can be structured as an SDIO compliment memory card, so that by adding an extended pin unit or the like to an existing SD interface, an electronic device system can be structured that prevents the processing by a program stored in a non-certified storage medium.

### Second Embodiment

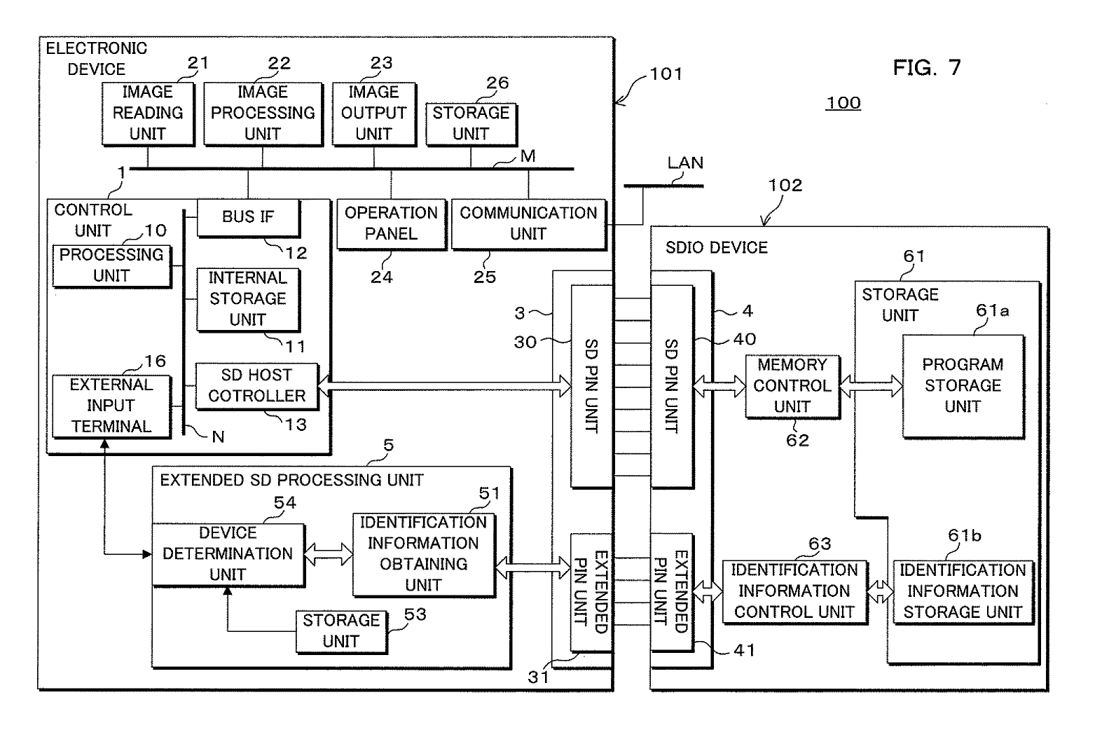

FIG. 7 is a block diagram showing the functional structure of the inside of the electronic device 101 and the SDIO device 102 included in the electronic device system 100 according to a second embodiment of the present invention. In the second embodiment, the extended SD processing unit 5 is provided with a storage unit 53 storing the identification information of the SDIO device 102 and a device determination unit (determination unit) 54 that determines whether the identification information obtained from the SDIO device 102 coincides with the stored identification information or not, and the control unit 1 is provided with an external input terminal 16. Since the structure, other than this, of the electronic device system 100 according to the second embodiment is similar to the structure of the electronic device system according to the first embodiment, similar parts are denoted by the same reference designations, and detailed descriptions thereof are omitted.

The extended SD processing unit 5 obtains the identification information of the SDIO device 102 through the extended pin unit 31 by the identification information obtaining unit 51. The device determination unit 54 determines whether the identification information of the SDIO device 102 obtained by the identification information obtaining unit 51 coincides with the identification information of the SDIO device 102 stored in the storage unit 53 or not, and outputs the determination result to the external input terminal 16 to notify the control unit 1 of the determination result.

The control unit 1 controls the execution of the processing by the control program based on the determination result inputted from the external input terminal 16. Here, since the boot processing by the control unit 1 and the reading of the control program from the SDIO device 102 and its execution are independent of the determination processing by the extended SD processing unit 5, it is assumed that the processing unit 10 of the control unit 1 has started the processing by the control program read by the SD host controller 13, prior to the notification of the determination result. When the determination result inputted from the external input terminal 16 indicates that the identification information does not coincide, the control unit 1 stops the processing by the control program.

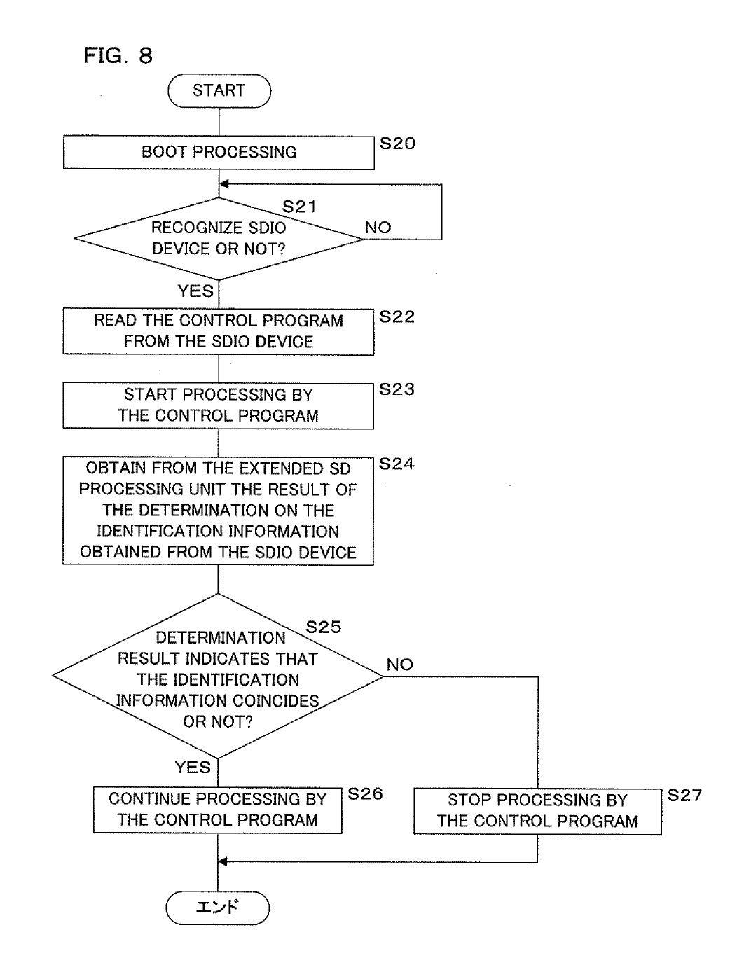

Next, the processing when the control program is read from the SDIO device 102 to the electronic device 101 and executed will be described. FIG. 8 is a flowchart showing the processing procedure when the control program is read from the SDIO device 102 to the electronic device 101 and executed in the second embodiment. When the electronic device 101 is turned on, the control unit 1 performs the boot processing at step S20 and the check of the recognition of the SDIO device 102 at step S21. The processings at steps S20 and S21 are the same as the processings at steps S10 and S11 of FIG. 6, and descriptions thereof are omitted for simplification.

When the SDIO device 102 has been recognized (S21: YES), the control program is read from the SDIO device 102 through the SD pin unit 30 by the SD host controller 13 (step S22). The processing unit 10 starts the processing by the control program read by the SD host controller 13 (step S23). The processing unit 10 having started the processing by the control program obtains from the extended SD processing unit 5 the result of the determination on the identification information obtained from the SDIO device 102 (step S24).

The processing unit 10 determines whether the determination result obtained from the extended SD processing unit 5 indicates that the identification information coincides or not (step S25). When it indicates that the identification information coincides (S25: YES), the processing unit 10 continues the processing by the control program (step S26). On the other hand, when it indicates that the identification information does not coincide (S25: NO), the processing unit 10 determines the SDIO device 102 as a non-certified one, and stops the processing by the control program (step S27).

As described above, in the present embodiment, the extended SD processing unit 5 is provided with the device determination unit 54, determines whether the identification information obtained from the SDIO device 102 coincides with the identification information stored in the extended SD processing unit 5 or not, and notifies the control unit 1 of the determination result through the external input terminal 16. The processing unit 10 of the control unit 1 has started the processing by the control program read by the SD host controller 13, prior to the notification of the determination result, and when the determination result inputted from the external input terminal 16 indicates that the identification information does not coincide, the processing unit 10 stops the processing by the control program. By doing this, the processing by the control program at the time of activation of the electronic device system 100 can be started early, and the execution of the control program stored in a non-certified SDIO device can be stopped. Moreover, by providing the device determination unit 54 outside the control unit 1, the function at the control unit 1 can be simplified.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An electronic device system comprising:
a storage medium storing a program; and
an electronic device to which the storage medium is detachably connected so as to execute processing by a program read from the storage medium, wherein
the storage medium is provided with:
a storage unit storing the program and identification information;
a first pin for outputting the program stored in the storage unit; and
a second pin for outputting the identification information stored in the storage unit, and
the electronic device is provided with:
a third pin connected to the first pin;
a fourth pin connected to the second pin;
a program reading unit connected to the third pin for reading the program;
a determination unit for determining whether or not the identification information obtained through the fourth pin coincides with prestored identification information; and
a processing unit that executes processing by the program read by the program reading unit when the determination unit determines that the identification information coincides.

2. The electronic device system according to claim 1, wherein
the program reading unit reads the program when the determination unit determines that the identification information coincides.

3. The electronic device system according to claim 1, wherein
the determination unit notifies the processing unit of the determination result, and
the processing unit starts processing by the program read by the program reading unit, prior to the notification of the determination result, and when the determination result indicates that the identification information does not coincide, the processing unit stops processing by the program.

4. The electronic device system according to claim 1, wherein
the storage medium is an SDIO (secure digital input output) compliant memory card in which a plurality of pins including the first pin have an SD (secure digital) interface and the second pin is provided.

5. The electronic device system according to claim 1, wherein
the electronic device is provided with an identification information obtaining unit connected to the fourth pin so as to obtain the identification information stored in the storage unit and output the identification information to the determination unit, and
the identification information obtaining unit outputs predetermined information when the identification information stored in the storage unit is not detected.

6. The electronic device system according to claim 2, wherein
the electronic device is provided with an identification information obtaining unit connected to the fourth pin so as to obtain the identification information stored in the storage unit and output the identification information to the determination unit, and
the identification information obtaining unit outputs predetermined information when the identification information stored in the storage unit is not detected.

7. The electronic device system according to claim 3, wherein
the electronic device is provided with an identification information obtaining unit connected to the fourth pin so as to obtain the identification information stored in the storage unit and output the identification information to the determination unit, and
the identification information obtaining unit outputs predetermined information when the identification information stored in the storage unit is not detected.

8. The electronic device system according to claim 4, wherein
the electronic device is provided with an identification information obtaining unit connected to the fourth pin so as to obtain the identification information stored in the storage unit and output the identification information to the determination unit, and
the identification information obtaining unit outputs predetermined information when the identification information stored in the storage unit is not detected.

9. An electronic device that reads a program from an external storage medium and executes processing, the electronic device comprising:
a program input pin to which the program is inputted;
an identification information input pin to which identification information is externally inputted;
a program reading unit connected to the program input pin for reading the program;
a determination unit for determining whether or not the identification information obtained through the identification information input pin coincides with prestored identification information; and
a processing unit that executes processing by the program read by the program reading unit when the determination unit determines that the identification information coincides.

10. The electronic device according to claim 9, wherein
the program reading unit reads the program when the determination unit determines that the identification information coincides.

11. The electronic device according to claim 9, wherein
the determination unit notifies the processing unit of the determination result, and
the processing unit starts processing by the program read by the program reading unit, prior to the notification of the determination result, and when the determination result indicates that the identification information does not coincide, the processing unit stops processing by the program.

12. The electronic device according to claim 9, wherein
the electronic device is provided with an identification information obtaining unit connected to the identification information input pin so as to obtain the inputted identification information and output the identification information to the determination unit, and
the identification information obtaining unit outputs predetermined information when the identification information to be inputted is not detected.

13. The electronic device according to claim 10, wherein
the electronic device is provided with an identification information obtaining unit connected to the identification information input pin so as to obtain the inputted identification information and output the identification information to the determination unit, and
the identification information obtaining unit outputs predetermined information when the identification information to be inputted is not detected.

14. The electronic device according to claim 11, wherein
the electronic device is provided with an identification information obtaining unit connected to the identification information input pin so as to obtain the inputted identification information and output the identification information to the determination unit, and
the identification information obtaining unit outputs predetermined information when the identification information to be inputted is not detected.

15. A storage medium connected to an external electronic device and from which a stored program is read, the storage medium comprising:
a storage unit storing the program and identification information;
a pin for outputting the program; and
a pin for outputting the identification information.

16. The storage medium according to claim 15, wherein
the storage medium is an SDIO compliant memory card in which a plurality of pins including the pin for outputting the program have an SD interface and the pin for outputting the identification information is provided.
